(19) United States
(12) Patent Application Publication
(10) Pub. No.: US 2012/0145268 A1
(43) Pub. Date: Jun. 14, 2012

(54) Exhaust Ejector For An Internal Combustion Engine

(75) Inventors: Bryan Clarke, Aurora, IL (US); Christopher Lee, Eureka, IL (US); Rajendra Sharma, Wuxi (CN); Praveen Kumar Reddy Mallu, Oswego, IL (US)

(73) Assignee: CATERPILLAR INC., Peoria, IL (US)

(21) Appl. No.: 12/962,998

(22) Filed: Dec. 8, 2010

(51) Int. Cl. F16L 55/027

(52) U.S. Cl. 138/40

(57) ABSTRACT

An exhaust stack for an internal combustion engine includes an upstream segment having a proximal portion and a distal portion, and a downstream segment. The distal portion of the upstream segment has a non-circular cross section and at least partially defines a venturi opening. The downstream segment has a downstream proximal portion that at least partially defines the venturi opening. The distal portion defines a flow area that is less than or equal to a flow area of the proximal portion, and defines a perimeter that is greater than a perimeter of the proximal portion.

### TECHNICAL FIELD

The present disclosure relates generally to an exhaust ejector of an exhaust stack for an internal combustion engine, and more particularly to an exhaust ejector geometry that provides some independent control over entrainment flow versus backpressure.

### BACKGROUND

Many on-highway and off-highway vehicles use an exhaust stack for pulling hot exhaust gas away from the internal combustion engine. Some of these exhaust stacks include a venturi opening for entraining engine compartment air with the exhaust gas exiting the internal combustion engine and, typically, the engine compartment. The engine compartment air, which may also reach relatively high temperatures, is thus pulled out of the engine compartment and, in some cases, may cool and/or dilute the exhaust gas. Exhaust stacks including a venturi opening typically include an exhaust ejector positioned upstream from the venturi opening and a segment of pipe positioned downstream from the venturi opening. A distal portion or end of the exhaust ejector has a reduced diameter and, thus, reduced flow area, relative to a proximal portion of the exhaust ejector. This reduction in diameter increases the velocity of the exhaust gas traveling through the exhaust ejector and, as a result, decreases the fluid pressure of the exhaust gas at the distal portion of the ejector. Higher pressure engine compartment air is thus entrained into the exhaust gas through the venturi opening, and exhausted with the exhaust gas through the downstream pipe of the exhaust stack.

U.S. Pat. No. 7,207,172 to Willix et al. discloses an exhaust system having an air intake for admitting air from the engine compartment into an exhaust outlet duct of the exhaust system and entraining the engine compartment air together with the exhaust gas. Specifically, the air intake includes an air baffle element, which leads the engine compartment air into the exhaust outlet duct near a venturi opening. A small gap, positioned just upstream from the venturi opening, which allows passage of the exhaust gas from an exhaust pipe to the exhaust outlet duct defines a reduced flow area, relative to an upstream portion of the exhaust outlet duct, to entrain engine compartment air directed by the air baffle element into the exhaust gas. Although this reference may utilize a venturi effect, also referred to as an ejector effect, to entrain engine compartment air with the exhaust gas, the reduced exhaust flow area may contribute to unacceptable backpressure, which may negatively impact fuel efficiency and engine operation.

The present disclosure is directed to one or more of the problems set forth above.

### SUMMARY OF THE DISCLOSURE

In one aspect, an exhaust stack for an internal combustion engine includes an upstream segment having a proximal portion and a distal portion, and a downstream segment. The distal portion of the upstream segment has a non-circular cross section and at least partially defines a venturi opening. The downstream segment has a downstream proximal portion that at least partially defines the venturi opening. The distal portion defines a flow area that is less than or equal to a flow area of the proximal portion, and defines a perimeter that is greater than a perimeter of the proximal portion.

In another aspect, an off-highway machine includes an internal combustion engine mounted on a frame and having an exhaust manifold. An exhaust stack is configured for attachment to the exhaust manifold and includes an upstream segment having a proximal portion and a distal portion, and a downstream segment. The distal portion of the upstream segment has a non-circular cross section and at least partially defines a venturi opening. The downstream segment has a downstream proximal portion that at least partially defines the venturi opening. The distal portion defines a flow area that is less than or equal to a flow area of the proximal portion, and defines a perimeter that is greater than a perimeter of the proximal portion.

In yet another aspect, an upstream segment of an exhaust stack for an internal combustion engine includes a proximal portion having a circular cross section and a distal portion having a non-circular cross section. The non-circular cross section of the distal portion is defined by a plurality of inner walls having a first radius from a central axis of the upstream segment and a plurality of outer walls having a second radius from the central axis. The second radius is greater than the first radius. The distal portion defines a flow area that is less than or equal to a flow area of the proximal portion and defines a perimeter that is greater than a perimeter of the proximal portion.

### BRIEF DESCRIPTION OF THE DRAWINGS

FIG. 1 is a side diagrammatic view of a machine, according to one embodiment of the present disclosure;

FIG. 2 is a perspective view of an exhaust stack having an upstream segment and a downstream segment that may be used with the machine of FIG. 1;

FIG. 3 is a perspective view of a prior art upstream segment for use with the exhaust stack of FIG. 2 and having a circular cross section at a distal end thereof;

FIG. 4 is a perspective view of an upstream segment of the exhaust stack of FIG. 2 having a lobed distal end, according to one embodiment of the present disclosure;

FIG. 5 is a sectioned view taken along lines 5-5 of FIG. 2, wherein the upstream segment includes the lobed distal end of FIG. 4;

FIG. 6 is a perspective view of an upstream segment for use with the exhaust stack of FIG. 2, according to an alternative embodiment of the present disclosure;

FIG. 7 is a perspective view of an upstream segment for use with the exhaust stack of FIG. 2, according to another alternative embodiment of the present disclosure;

FIG. 8 is a perspective view of the upstream segment of FIG. 4, illustrating a manufacturing option for the upstream segment, according to one aspect of the present disclosure; and

FIG. 9 is a perspective view of the upstream segment of FIG. 4 including an insulating shield, according to one aspect of the present disclosure.

### DETAILED DESCRIPTION

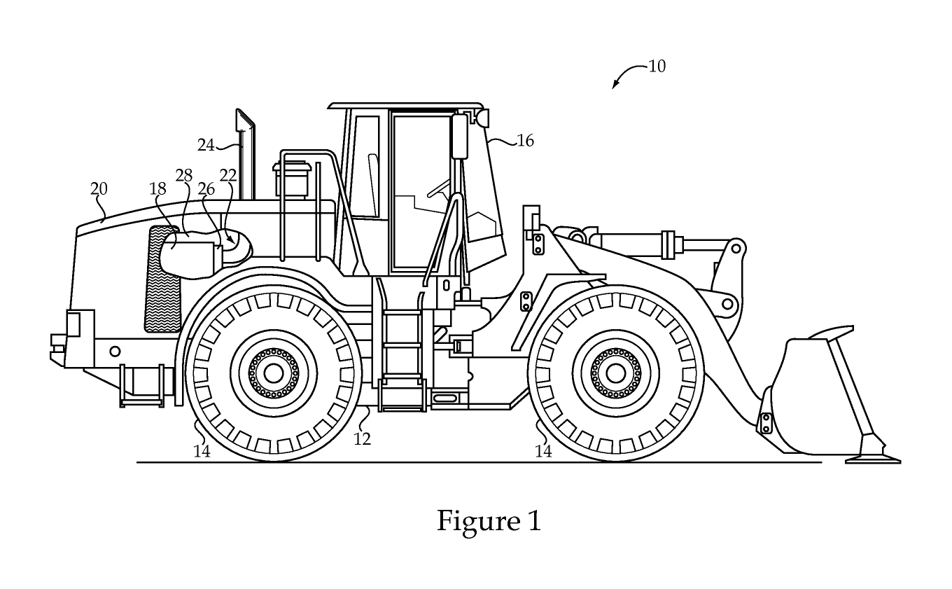

An exemplary embodiment of a machine 10 is shown generally in FIG. 1. The machine 10 may be an on-highway or off-highway vehicle, such as, for example, a wheel loader, or may be a stationary machine, such as a generator set. The machine 10 may include a frame 12, ground engaging elements, such as wheels 14, mounted to the frame 12, and an operator control station 16 also mounted to the frame 12. Machine 10 may further include an internal combustion engine 18 positioned at a rear portion of the machine 10, such as under a hood 20. An exhaust system 22 may include an exhaust stack 24 attached to an exhaust manifold 26 of the internal combustion engine 18 for removing exhaust gas produced by the internal combustion engine 18 from the engine compartment 28. Although the exhaust gas is shown as being exhausted in a substantially upward fashion, the exhaust gas may be exhausted from the machine 10 in any direction.

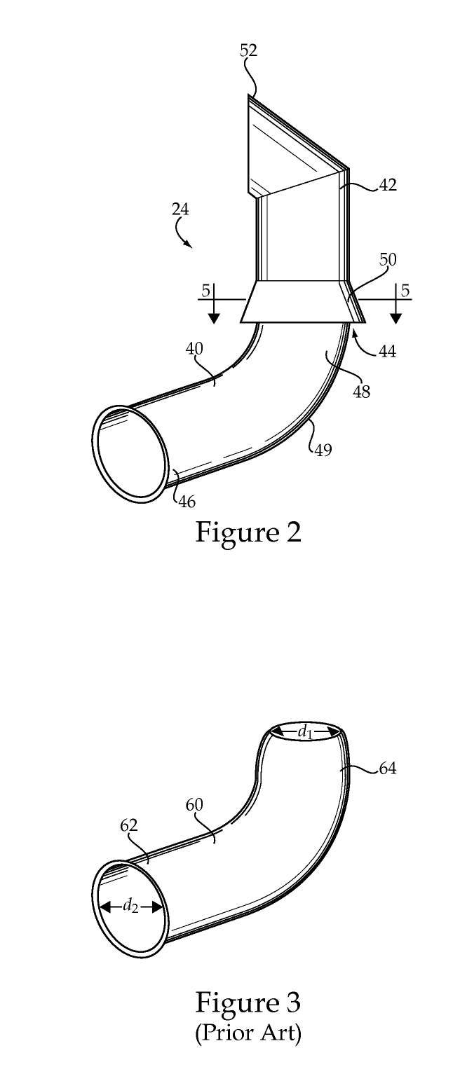

Turning now to FIG. 2, an exemplary embodiment of the exhaust stack 24 may generally include an upstream segment 40 and a downstream segment 42. The upstream segment 40 may be configured to attach to the exhaust manifold 26 (FIG. 1) or another component of the exhaust system 22. It should be appreciated that the exhaust system 22 may include a number of additional features well known in the art, such as, for example, a diesel particulate filter and an exhaust gas recirculation system. However, those features are not within the scope of the present disclosure and, therefore, will not be discussed. The upstream segment 40 is positioned upstream from a venturi opening 44 and has a proximal portion 46 and a distal portion 48. “Proximal,” as used herein, may refer to a component or portion that is in closer proximity to the exhaust manifold 26 than a “distal” component or portion. A curved portion 49, specific to the exemplary embodiment, may be positioned between the proximal portion 46 and the distal portion 48. As shown, the distal portion 48 at least partially defines the venturi opening 44. The downstream segment 42 is positioned downstream from the venturi opening 44 and has a downstream proximal portion 50 that at least partially defines the venturi opening 44.

According to one embodiment, the upstream segment 40 of the exhaust stack 24 and at least the downstream proximal portion 50 of the downstream segment 42 are positioned below the hood 20 of FIG. 1 and within the engine compartment 28. As such, the exhaust stack 24 may be configured to not only remove exhaust gas produced by the internal combustion engine 18 from the engine compartment 28, but also entrain hot engine compartment air into the exhaust stack 24 through the venturi opening 44. The mixture of exhaust gas and engine compartment air is then directed through a distal portion 52 of the downstream segment 42 into the ambient air. The drawing in of engine compartment air into the exhaust stack 24 in a manner described herein may be referred to as a venturi effect, an ejector effect, or an entrainment flow. Further, the upstream segment 40 may also be referred to as an exhaust ejector and the exhaust stack 24 may be referred to as a venturi exhaust stack.

Turning now to FIG. 3, an upstream segment 60, or exhaust ejector, of a prior art exhaust stack is shown. The prior art upstream segment 60 may be positioned upstream from a venturi opening, similar to venturi opening 44 of FIG. 2, and may include a proximal portion 62 and a distal portion 64. The distal portion 64 of the prior art upstream segment 60 may at least partially define the venturi opening and may include a circular cross section having a reduced diameter d₁ relative to a diameter d₂ of the proximal portion 62. The reduced diameter d₁ and, thus, reduced flow area at the distal portion 64, relative to the proximal portion 62, may increase a velocity of exhaust gas flowing through the upstream segment 60 at the distal portion 64. As the exhaust gas flows more quickly through the distal portion 64 the fluid pressure of the exhaust gas decreases, thus creating a venturi effect or ejector effect at the venturi opening. Specifically, the higher pressure engine compartment air may be drawn into, or entrained with, the lower pressure exhaust gas at the venturi opening.

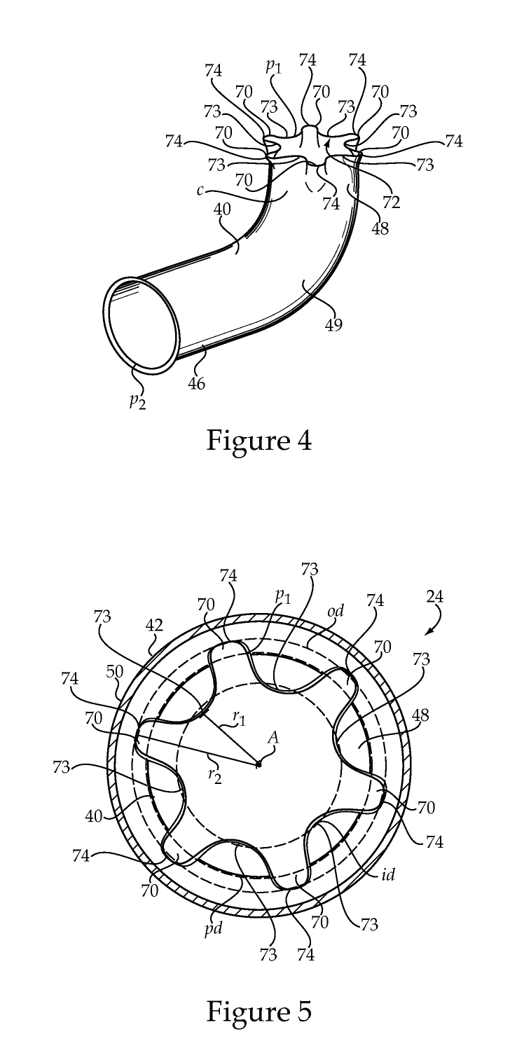

According to the present disclosure, the distal portion 48 of the upstream segment 40, as shown in the exemplary embodiment of FIG. 4, has a non-circular cross section. As shown, the distal portion 48 may include a plurality of lobes 70 spaced about a perimeter p₁ of the distal portion 48. Although six lobes 70 are shown in the embodiment of FIG. 4, any number of lobes, or other shapes, may be used per the present disclosure. Further, although the lobes 70 are shown as equidistantly spaced about the perimeter p₁, the lobes 70, or other shapes, may provide a symmetrical arrangement or an asymmetrical arrangement about the perimeter p₁ of the distal portion 48. As will become apparent herein, a lobed design is only one of a number of non-circular designs that may be used according to the present disclosure.

The distal portion 48 of the upstream segment 40, or exhaust ejector, is shaped to provide an entrainment flow of engine compartment air into the exhaust gas traveling through the exhaust stack 24 at the venturi opening 44. Specifically, the distal portion 48 is shaped to decrease a fluid pressure of the exhaust gas at the distal portion 48 without significantly reducing the flow area of the distal portion 48 relative to the flow area at the proximal portion 46, which may have a circular cross section. This decrease in fluid pressure, as described herein, is achieved by increasing a surface area of a boundary layer 72 at the distal portion 48. As should be appreciated, the increased surface area is achieved by increasing the perimeter p₁ at the distal portion 48 relative to the perimeter p₂ at the proximal portion 46. The entrainment flow produced using such a design may be similar to or increased relative to the entrainment flow produced by prior art designs, such as the one described above. Further, because the non-circular distal portion design does not rely upon a reduced diameter at the distal portion 48, as the prior art designs require, the designs of the present disclosure do not produce the backpressure commonly experienced with the prior art designs.

As should be appreciated, an upstream segment 40 contemplated by the present disclosure will have a perimeter p₁ at the distal portion 48 that is greater than a perimeter p₂ at the proximal portion 46. Further, although the flow area may be similar throughout the upstream segment 40, it is preferable that the flow area of the distal portion 48 be less than or equal to a flow area of the proximal portion 46. Although the flow area may be reduced at the distal portion 48, relative to the proximal portion 46, it need not be reduced as much as prior art designs that utilize distal portions having circular cross sections. According to one example, the flow area of the distal portion 48 may be between about 0.5 and 1.0 times the flow area of the proximal portion 46. In addition, the perimeter p₁ of the distal portion 48 may be between about 1.0 and 3.0 times the perimeter p₂ of the proximal portion 46.

Continuing with the exemplary embodiment of FIGS. 2 and 4, a cross section of the exhaust stack 24 taken along lines 5-5 of FIG. 2 is shown in FIG. 5. As shown, the exhaust stack 24 includes the upstream segment 40 having the lobed distal end depicted in FIG. 4. Also depicted in FIG. 5 is an outer diameter od, which represents a diameter of the distal portion 48 measured from the tops of the lobes 70, an inner diameter id, which represents a diameter of the distal portion 48 measured from the bases of the lobes, and a pitch diameter pd, which lies on the tangent points between the inner and outer lobes. A pitch depth may represent od−id, while a pitch ratio may represent pd−id/od−id. These are only a few examples of dimensions, and/or non-dimensional parameters, that may serve as control factors in a computational fluid dynamics (CFD) model.

For example, it may be desirable to create a CFD model of the upstream segment 40 in order to test different geometries of distal portion 48. Specifically, the CFD model may be used to evaluate the probable entrainment flow and backpressure produced by different geometries. Control factors, such as the dimensional or non-dimensional parameters described above, may be varied to identify one or more geometries that produce entrainment flow and backpressure within desirable ranges. Some control factors, such as the pitch diameter pd and pitch depth, may be found to have the greatest impact on entrainment flow and/or backpressure and, thus, may be the control factors most often adjusted. However, in some instances, application restrictions or limitations may dictate the values for some control factors, thus limiting the design flexibility.

According to some embodiments, as should be appreciated, the non-circular cross section of the distal portion 48 may be defined by a plurality of inner walls 73 having a first radius r₁ from a central axis A of the upstream segment 40, and a plurality of outer walls 74 having a second radius r₂ from the central axis A. According to the exemplary embodiment, the second radius r₂ is greater than the first radius r₁. Further, as shown in the exemplary embodiment, the inner walls 73 and outer walls 74 may alternate about the perimeter p₁ such that an inner wall 73 is positioned between two outer walls 74, and an outer wall 74 is positioned between two inner walls 73. The inner walls 73 may have a concave curvature, as shown, and the outer walls 74 may have a convex curvature, as shown. As such, the outer walls 74 may define lobes 70 spaced about the perimeter p₁.

In addition, and referring back to FIG. 4, a circumference c of the distal portion 48 may include a proximal to distal taper at each inner wall 73 and a proximal to distal rise at each outer wall 74. The proximal to distal taper may represent a decrease, such as a gradual decrease, in circumference of the distal portion 48 from a proximal region of the distal portion 48 to a distal region of the distal portion 48 at each of the inner walls 73. Conversely, the proximal to distal rise may represent an increase, such as a gradual increase, in circumference of the distal portion 48 from a proximal region of the distal portion 48 to a distal region of the distal portion 48 at each of the outer walls 74. The circumference, as should be appreciated, refers to the outer boundary or surface of the distal portion 48.

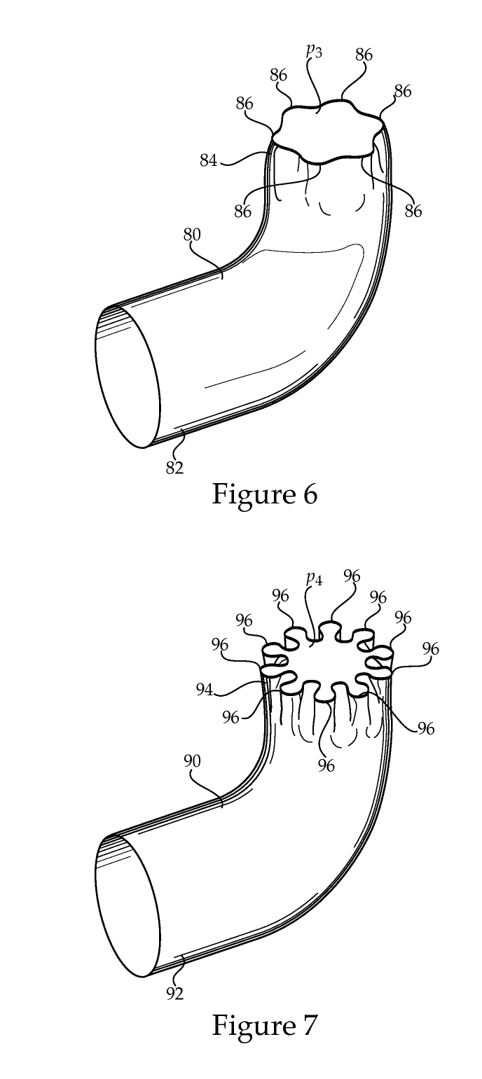

Turning now to FIG. 6, an alternative embodiment of an upstream segment 80 according to the present disclosure is shown. Generally, the upstream segment 80 may include a proximal portion 82 and a distal portion 84 and may be similar to upstream segment 40 with the exception of the distal portion 84. Specifically, although the distal portion 84 may include a similar number of lobes 86 spaced about the perimeter p₃, a pitch depth, as described above, of the lobes 86 may be less than a pitch depth of the lobes 70 of upstream segment 40. Further, the pitch ratio of the lobes 86 may be less than a pitch ratio of the lobes 70 of the upstream segment 40. This may result in a decreased perimeter p₃ relative to the perimeter p₁ of the embodiment of FIG. 4, and a decreased flow area. Such a design may be evaluated for efficiency regarding entrainment flow versus backpressure and fuel consumption.

Turning now to FIG. 7, another alternative embodiment of an upstream segment 90 according to the present disclosure is shown. Generally, the upstream segment 90 may include a proximal portion 92 and a distal portion 94 and may include ten lobes 96 spaced about the perimeter p₄. As should be appreciated, a pitch depth, as described above, of the lobes 96 may be greater than a pitch depth of the lobes 70 of upstream segment 40. Further, the pitch ratio of the lobes 96 may be greater than a pitch ratio of the lobes 70 of the upstream segment 40. This may result in a decreased perimeter p₄ relative to the perimeter p₁ of the embodiment of FIG. 4, and a decreased flow area. Again, such a design may be evaluated for efficiency regarding entrainment flow versus backpressure and fuel consumption.

Although lobed embodiments are shown, it should be appreciated that any of a number of non-circular cross sections may be selected for the distal portion 48 of upstream segment 40. For example, the cross section of distal portion 48 may include a triangle or star shape, or other polygonal shape. Alternatively, the cross section of distal portion 48 may include a non-circular free-form shape that is free from sharp corners or edges. The selected geometries may include twists and may extend any length along the distal portion 48 of upstream segment 40. Although a curved portion 49 is shown in one of the exemplary embodiments, it should be appreciated that the upstream segment 40 may or may not incorporate curves or bends and may be any desired length.

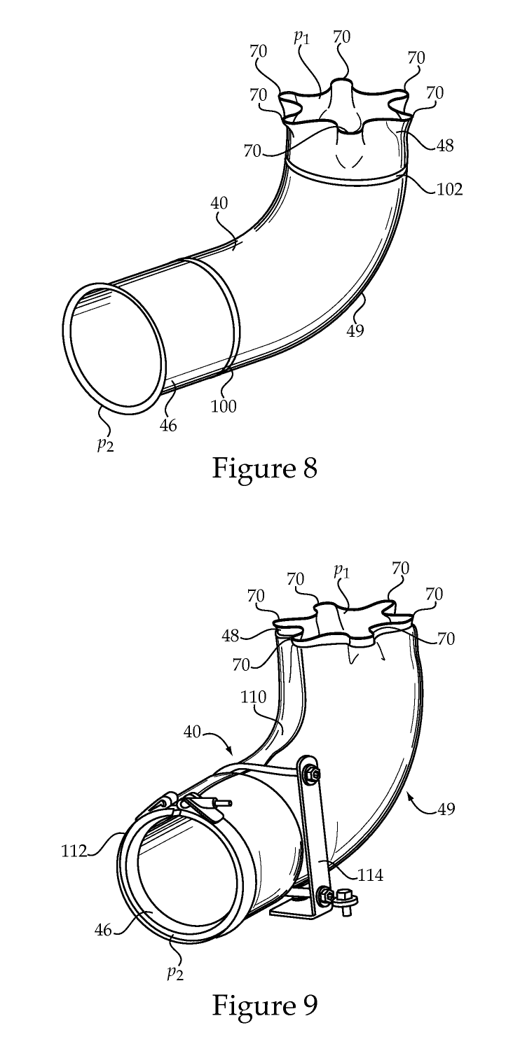

FIG. 8 is a perspective view of the upstream segment 40 of FIG. 4, illustrating a manufacturing option for the upstream segment 40. Specifically, the proximal portion 46, the curved portion 49, and the distal portion 48 may all be manufactured or formed as separate components. The components may then be fastened together using any preferable attachment means. For example, the proximal portion 46 may be joined with the curved portion 49 at a first weldment 100, while the curved portion 49 may be joined with the distal portion 48 at a second weldment 102. Additional components, depending on a particular application, may also be provided with the upstream segment 40. For example, as shown in FIG. 9, an insulating shield 110 may be provided around the upstream segment 40. One or more attachment features, such as attachment features 112 and 114, may be provided to maintain the positioning of the insulating shield 110 relative to the upstream segment 40 and/or maintain a specific positioning of the upstream segment 40 within the exhaust system 22 of machine 10.

### INDUSTRIAL APPLICABILITY

The present disclosure may find particular applicability to machines having exhaust systems utilizing venturi openings. Further, the present disclosure may be particularly applicable to applications where improved entrainment flow of engine compartment air into exhaust gas is desired. The present disclosure may be specifically applicable to such applications requiring a desirable entrainment flow with minimal resulting backpressure.

Referring to FIGS. 1-9, an exemplary embodiment of a machine 10 may include an internal combustion engine 18 supported on a frame 12 and having an exhaust manifold 26. An exhaust stack 24 is configured for attachment to the exhaust manifold 26 and includes an upstream segment 40, also referred to as an exhaust ejector, and a downstream segment 42. The upstream segment 40 is positioned upstream from a venturi opening 44 and has a proximal portion 46 and a distal portion 48. As shown, the distal portion 48 at least partially defines the venturi opening 44. The downstream segment 42 is positioned downstream from the venturi opening 44 and has a downstream proximal portion 50 that at least partially defines the venturi opening 44.

During operation of the machine 10, and according to the exemplary embodiment provided herein, exhaust gas may be directed from the exhaust manifold 26 through the upstream segment 40 of the exhaust stack 24. This includes decreasing or maintaining a flow area at the distal portion 48 of the upstream segment 40 relative to the proximal portion 46 of the upstream segment 40, and decreasing a fluid pressure of the exhaust gas at the distal portion 48 by increasing a surface area of a boundary layer at the distal portion 48 relative to the proximal portion 46. Engine compartment air is entrained into the exhaust gas through the venturi opening 44, and the mixture of exhaust gas and entrained engine compartment air is directed through the downstream segment 42 of the exhaust stack 24.

The distal portion 48 of the upstream segment 40 is shaped to provide an entrainment flow of engine compartment air into the exhaust gas traveling through the exhaust stack 24 at the venturi opening 44. Specifically, the distal portion 48 is shaped to decrease a fluid pressure of the exhaust gas at the distal portion 48 without significantly reducing the flow area of the distal portion 48 relative to the flow area at the proximal portion 46. This decrease in fluid pressure, as described herein, is achieved by increasing a perimeter p₁ and, thus, a surface area of a boundary layer 72 at the distal portion 48. As a result, entrainment flow is increased. However, backpressure is not significantly increased, which is common with prior art designs. Thus, by selecting appropriate geometry at distal portion 48, some independent control over entrainment flow rate and engine backpressure are afforded to the system designers.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An exhaust stack for an internal combustion engine, including:
an upstream segment having a proximal portion and a distal portion, wherein the distal portion has a non-circular cross section and at least partially defines a venturi opening; and
a downstream segment having a downstream proximal portion that at least partially defines the venturi opening;
the distal portion defining a flow area that is less than or equal to a flow area of the proximal portion;
the distal portion defining a perimeter that is greater than a perimeter of the proximal portion.

2. The exhaust stack of claim 1, wherein the distal portion includes a plurality of lobes spaced about the perimeter.

3. The exhaust stack of claim 2, wherein the distal portion includes six lobes equidistantly spaced about the perimeter.

4. The exhaust stack of claim 1, wherein the flow area of the distal portion is between about 0.5 and 1.0 times the flow area of the proximal portion.

5. The exhaust stack of claim 1, wherein the perimeter of the distal portion is between about 1.0 and 3.0 times the perimeter of the proximal portion.

6. The exhaust stack of claim 1, wherein the upstream segment includes a curved portion positioned between the proximal portion and the distal portion.

7. The exhaust stack of claim 6, wherein the proximal portion has a circular cross section.

8. An off-highway machine, including:
a frame;
an internal combustion engine mounted on the frame and having an exhaust manifold; and
an exhaust stack configured for attachment to the exhaust manifold and including: an upstream segment having a proximal portion and a distal portion, wherein the distal portion has a non-circular cross section and at least partially defines a venturi opening; and a downstream segment having a downstream proximal portion that at least partially defines the venturi opening;
the distal portion defining a flow area that is less than or equal to a flow area of the proximal portion;
the distal portion defining a perimeter that is greater than a perimeter of the proximal portion.

9. The off-highway machine of claim 8, wherein the distal portion includes a plurality of lobes spaced about the perimeter.

10. The off-highway machine of claim 9, wherein the distal portion includes six lobes equidistantly spaced about the perimeter.

11. The off-highway machine of claim 8, wherein the flow area of the distal portion is between about 0.5 and 1.0 times the flow area of the proximal portion.

12. The off-highway machine of claim 8, wherein the perimeter of the distal portion is between about 1.0 and 3.0 times the perimeter of the proximal portion.

13. The off-highway machine of claim 8, wherein the upstream segment includes a curved portion positioned between the proximal portion and the distal portion.

14. The off-highway machine of claim 13, wherein the proximal portion has a circular cross section.

15. An upstream segment of an exhaust stack for an internal combustion engine, including:
a proximal portion having a circular cross section; and
a distal portion having a non-circular cross section defined by a plurality of inner walls having a first radius from a central axis of the upstream segment and a plurality of outer walls having a second radius from the central axis, wherein the second radius is greater than the first radius;
the distal portion defining a flow area that is less than or equal to a flow area of the proximal portion;
the distal portion defining a perimeter that is greater than a perimeter of the proximal portion.

16. The upstream segment of claim 15, wherein the inner walls and outer walls alternate about the perimeter.

17. The upstream segment of claim 16, wherein the inner walls have a concave curvature and the outer walls have a convex curvature.

18. The upstream segment of claim 17, further including six lobes defined by the outer walls and equidistantly spaced about the perimeter.

19. The upstream segment of claim 17, wherein a circumference of the distal portion includes a proximal to distal taper at each inner wall and a proximal to distal rise at each outer wall.

20. The upstream segment of claim 15, further including a downstream segment having a downstream proximal portion that at least partially defines a venturi opening of the exhaust stack, wherein the distal portion of the upstream segment at least partially defines the venturi opening.
